(19) United States
(12) Patent Application Publication
(10) Pub. No.: US 2017/0162337 A1
(43) Pub. Date: Jun. 8, 2017

(54) Electrode For Photovoltaic Cells And Associated Preparation Process

(71) Applicant: ENI S.P.A, Rome (IT)

(72) Inventors: Stefano Ramello, Novara (IT); Roberto Buzzoni, Chivasso (IT)

(21) Appl. No.: 15/129,905

(22) PCT Filed: Apr. 15, 2015
(86) PCT No.: PCT/EP2015/058121

§ 371 Date: Sep. 28, 2016

(30) Foreign Application Priority Data
Apr. 16, 2014 (IT) MI2014A000709

(51) Int. Cl. H01G 9/20

(52) U.S. Cl. CPC H01G 9/2022

(57) ABSTRACT

The present invention relates to an electrode comprising a conductive material and characterised by the fact of containing a porous crosslinked layer of metal particles, said metal particles being fused between them by a part of their outer surface, still leaving the remaining portion of the outer surface free, said particles being characterised in that they contain one or more metals selected from platinum, palladium, gold and mixtures thereof.

The present invention relates to an electrode for photovoltaic cells and a process for the preparation of said electrode.

In particular, the present invention relates to an electrode for photovoltaic cells which contains noble metals, such as those selected from Pt, Pd or Au.

Said electrode may be used as a cathode in DSSC-type photovoltaic cells (“dye sensitised solar cells”), giving a clear improvement in performance over the results that may be obtained with known cathodes.

In the present patent application, all the operating conditions indicated in the document should be understood as preferred conditions, even where this is not expressly stated.

For the purpose of the present discussion, the term “comprise” or “include” also includes the term “consist in” or “substantially consisting of”.

For the purpose of the present discussion, the definitions of ranges are always inclusive, unless specified otherwise.

The growing demand for energy is driving research towards the examination of new sources that provide alternatives to conventional ones. In particular, a topic of growing importance is the conversion of solar energy into electricity, making use of new photovoltaic technologies. Silicon photovoltaic cells are progressing towards second-generation technologies (thin layer, focusing of radiation); in all cases such technologies are still expensive, and the second-generation ones are currently not particularly efficient. Particularly in the last decade, the search for valid alternative technologies has resulted in the development of what is called the third generation of photovoltaic cells: this definition covers both photovoltaic cells based on other semiconductors, such as metal selenides and tellurides, and also in particular so-called organic photovoltaic cells, such as those called Grätzel cells (dye sensitised solar cells, or DSSCs). DSSCs operate by a mechanism of the photoelectrochemical type. The absorption of light and the charges separation (electrons and holes) take place separately. The first stage is brought about by a layer of dye (the photosensitiser) interacting, from the point of view of electron transfer, with the surface of nano-sized particles of titanium dioxide (the semiconductor) deposited on a transparent conductive glass. When the photosensitiser absorbs radiation, it produces a state of excitation and charge transfer, and the presence of carboxyl groups allows the excited electron to be transferred to the conduction band of the titanium dioxide, which transports it to the electrode (conductive glass). At the same time, a positive charge (hole) is transferred from the photosensitiser to an electrolyte mediator which transports the positive charge to the counter-electrode.

Cells of this kind are promising because of the low cost, which results from their simple manufacture and high level of efficiency, which at present reaches around 11% (with reference to the entire solar spectrum). Ideally, the absorption by the photosensitiser should as far as possible coincide with the spectrum of solar emissions; in this context there have been studies of various transition metal complexes and organic dyes, which rationalise the properties and behaviour by means of advanced quantum mechanics calculations.

The counter-electrode of a DSSC device must have good electrocatalytic properties (Dye Sensitized Solar Cells, eds. K. Kalyanasundram, EPFL Press, distributed by CRCC Press, 2010, p. 30 and p. 235). Said counter-electrode is usually made of platinum (Photoelectrochemical Cells/Dye-Sensitized Cells, K. R. Millington, Encyclopedia of Electrochemical Power Sources, 2009, 4, pp. 10-21).

As known from the literature, the dimensions and distribution of the Pt particles (morphology) are closely related and can determine the performance of the electrode.

An Iodine/Triiodide Reduction Electrocatalyst for Aqueous and Organic Media, M. Grätzel et al., J. Electrochem. Soc., Volume 144, Issue 3, pp. 876-884, 1997, describes nanoparticles of Pt of approximately 5 nm which are obtained from the thermal decomposition of H₂PtCl₆ dissolved in isopropanol, at a temperature of 385° C.; these particles prove to be those giving the best performance of those described in the said publication, thanks in part to the transparency of the cathode, which is due to the minimal amount of Pt used.

Electrodeposited Pt for cost-efficient and flexible dye-sensitized solar cells, S. S. Kim et al., Electrochimica Acta, 2006, 51, 3814-3819 compares the drastically different performance of two devices having cathodes, which are characterised by very different morphology of the deposited Pt: in the case of the first electrode, where pulsed electrodeposition is used, the formation of nano-clusters with dimensions below 40 nm and composed of particles of 3 nm was observed, in contrast to the formation of large agglomerates, approximately 500 nm in diameter, observed in the case of direct electrodeposition on the second electrode. The performance of the first electrode proved to be clearly superior to that of the second.

Within the context of electrocatalysis, it has been reported that the decomposition of precursors of Pt in polyalcohols, in particular ethylene glycol, results in the uniform distribution of particles of Pt both dimensions (below 5 nm) and in coverage of the substrate (Preparation and Characterization of Multiwalled Carbon Nanotube-Supported Platinum for Cathode Catalysts of Direct Methanol Fuel Cells, W. Li et al., J. Phys. Chem. B, 2003, 107, 26, pp 6292-6299). In this case, the decomposition took place at a temperature of 140° C., far below the boiling point of ethylene glycol (197° C.). In particular, the process of nucleation was favoured with respect to that of growth, with the result that the agglomeration of the particles was shown to be minimised (Surface-modified carbons as platinum catalyst support for PEM fuel cells, A. Guhaa et al., Carbon, Volume 45, Issue 7, June 2007, 1506-1517).

The materials prepared in this way display superior catalytic performance and longer lifetime. This method of preparation is known by the name of the “polyol process” (Structural Features and Catalytic Properties of Pt/CeO₂ Catalysts Prepared by Modified Reduction-Deposition Techniques, X. Tang et al., Catalysis Letters, Volume 97, Numbers 3-4, 163-169; Dye Sensitized Solar Cells, eds. K. Kalyanasundram, EPFL Press, distributed by CRCC Press, 2010, p. 31).

Devices are known which use extremely small quantities of Pt for the preparation of the cathode (Low-Cost Hydrogen-Evolution Catalysts Based on Monolayer Platinum on Tungsten Monocarbide Substrates, D. V. Esposito et al., Ang. Chem. Int. Ed., 2010, 49, 9859-9862; Minimizing the Use of Platinum in Hydrogen-Evolving Electrodes, I. E. L. Stephens and I. Chokendorff, Angew. Chem. Int. Ed., 2011, 50, 1476-1477; Pt/Mesoporous Carbon Counter Electrode with a Low Pt Loading for High-Efficient Dye-Sensitized Solar Cells, G. Wang et al., International Journal of Photoenergy, vol. 2010, Article ID 389182, 7 pages, 2010. doi:10.1155/2010/389182). Many studies forming part of this line of research describe how, in order to obtain good performance from the electrode, the morphology of the Pt deposited has to be controlled precisely (Synthesis of Monodisperse Pt Nanocubes and Their Enhanced Catalysis for Oxygen Reduction, C. Wang et al., J. Am. Chem. Soc. 2007, 129, 6974-6975; Imaging Structure Sensitive Catalysis on Different Shape-Controlled Platinum Nanoparticles, C. M. Sanchez-Sanchez et al., J. Am. Chem. Soc. 2010, 132, 5622-5624; A General Approach to the Size- and Shape-Controlled Synthesis of Platinum Nanoparticles and their Catalytic Reduction of Oxygen, C. Wang et al., Angew. Chem. Int. Ed., 2008, 47, 3588-3591).

Various products allowing optimised electrodes to be obtained are commercially available. Platisol T paste (Solaronix, http://www.solaronix.com) contains a chemical precursor of Pt dissolved in isopropanol and is used by means of screen printing. Another material very common in the laboratory is PT1 paste, an oil-based product intended for the same use (Dyesol, http://www.dyesol.com). Also commercially available from this manufacturer are glasses having conductive supports with deposited Pt, for example the glasses “Pt-Coated Test Glass Plates” (Dyesol, http://www.dyesol.com).

The object of the present invention is to propose new electrodes that are usable in photovoltaic cells and which have improved efficiency both in respect of the commercially available devices and in respect of the known devices which are disclosed in the prior art.

The applicant has thus prepared a new electrode which is characterised by a completely novel morphology and may be used in photovoltaic cells to improve efficiency.

Said new electrode comprises a conductive material and is characterised by the fact of containing a porous crosslinked layer of metal particles, said metal particles being fused between them by a part of their outer surface, still leaving the remaining portion of the outer surface free, and containing one or more metals selected from platinum, palladium, gold and mixtures thereof.

The metals are deposited on the conductive material by an innovative process, also described and claimed in the present document.

Such electrodes may be used in a photovoltaic cell which, thanks specifically to the new morphology of the crosslinked layer of particles, provides the technical advantage of improving the efficiency of said cells by up to 2% in absolute terms.

Other objects and advantages of the present invention will become clear from the description which follows and from the attached figures, which are provided purely by way of example and are not restrictive.

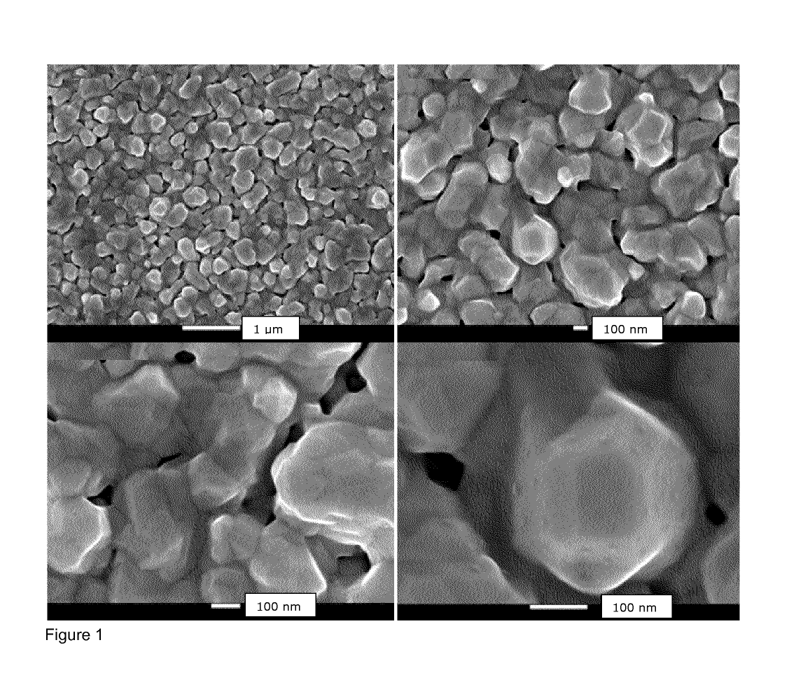

FIG. 1 is an SEM image of the sample prepared according to Example 1.

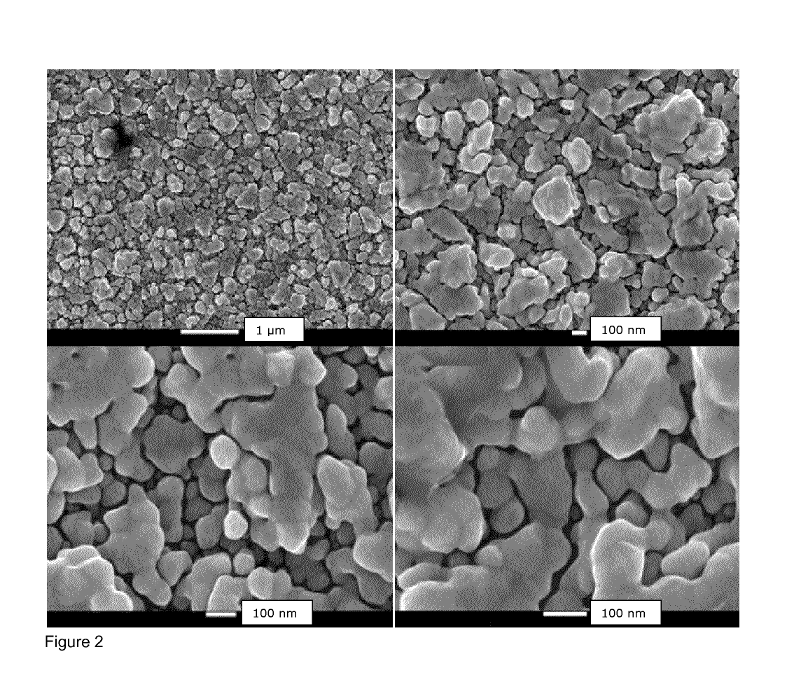

FIG. 2 is an SEM image of the sample prepared according to Example 2.

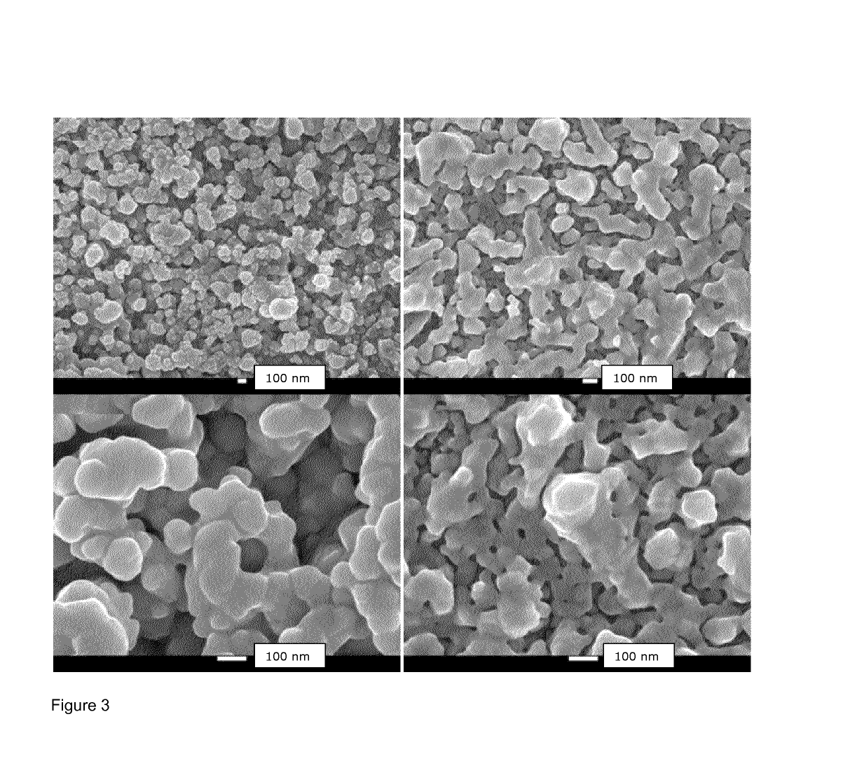

FIG. 3 is an SEM image of the sample prepared according to Example 3.

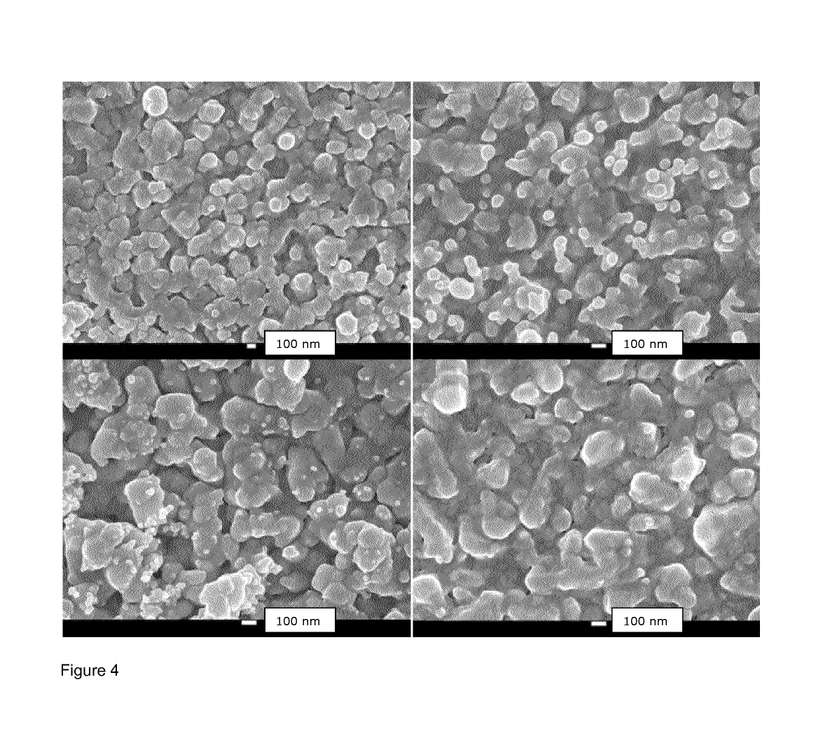

FIG. 4 is an SEM image of the sample prepared according to Example 4.

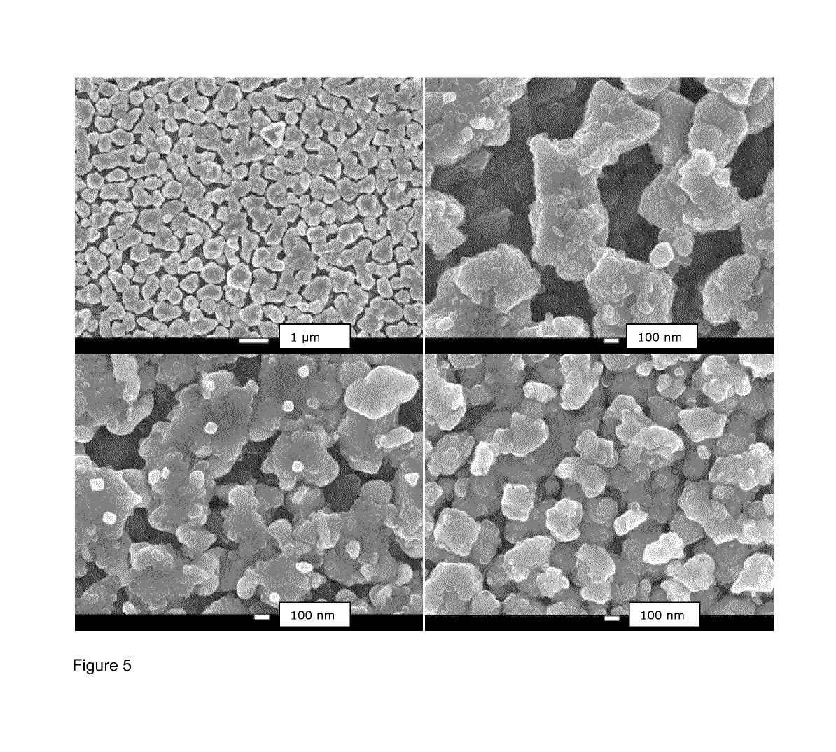

FIG. 5 is an SEM image of the sample prepared according to Example 5.

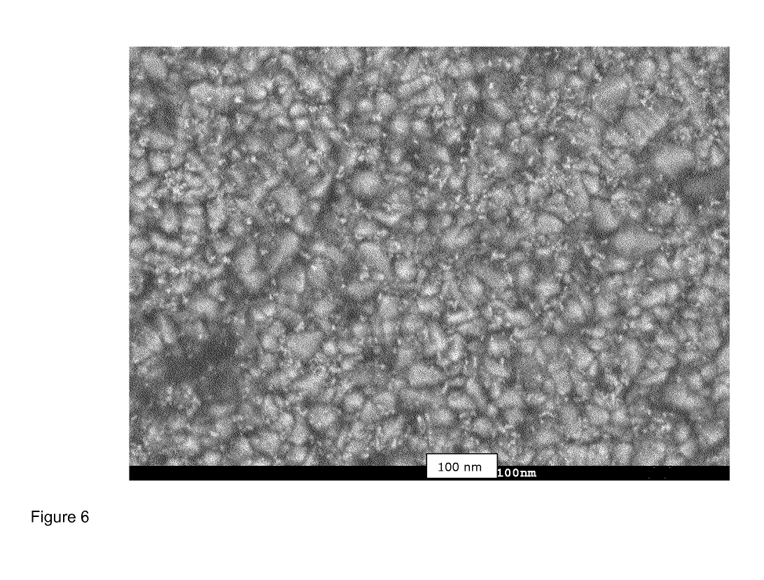

FIG. 6 is an SEM image of the sample prepared according to Comparative Example 6.

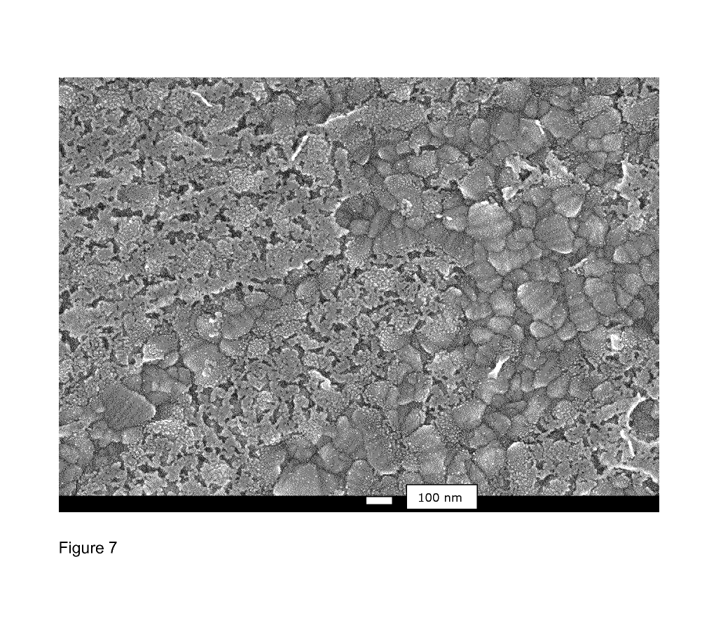

FIG. 7 is an SEM image of the sample prepared according to Comparative Example 7.

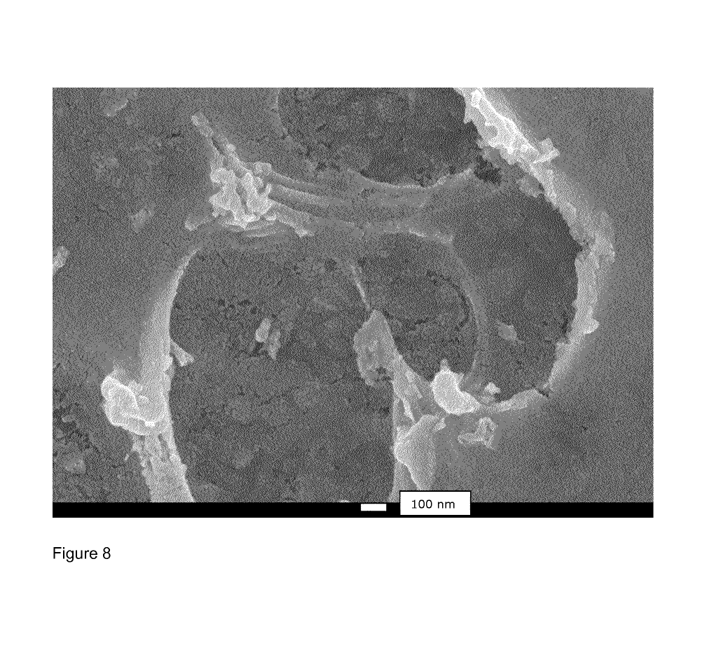

FIG. 8 is an SEM image of the sample prepared according to Comparative Example 8.

### DETAILED DESCRIPTION

The subject matter of the present invention is a new electrode comprising a conductive material and characterised by the fact of containing a porous crosslinked layer of metal particles, said metal particles being fused between them by a part of their outer surface, still leaving the remaining portion of the outer surface free, said particles containing one or more metals selected from platinum, palladium, gold and mixtures thereof.

The morphology of the porous crosslinked layer turns out to be entirely new and is characterised by a uniform coverage of the conductive material.

The particles making up the crosslinked layer may have irregular polyhedral shape but may also have a curved outer surface. Said particles are fused between them by at least a part of their outer surface, but are shown to be mutually discrete. The particles are not completely fused between them such to result in a uniform aggregate, as can be seen from the examples in FIGS. 1-5, which are provided purely by way of example and are not restrictive. The particles are fused between them in part such that they form discrete bodies which are joined solely by a portion of their outer surface, while the other portion is free.

Indeed, in FIGS. 1-5, the porous crosslinked layer comprises particles of irregular shape which are fused between them by at least a part of their outer surface such that they form a three-dimensional porous structure. Such particles are not therefore isolated elements that form an aggregate, but bodies that are fused between them while leaving part of their outer surface free.

Preferably, the metal particles which form the crosslinked layer in the electrode that is the subject matter of the present invention have an average diameter greater than 80 nm, and more preferably they have an average diameter between 80 nm and 190 nm, this average diameter being determined by scanning electron microscopy (SEM), as described in the literature (Bandarenka et al.: Comparative study of initial stages of copper immersion deposition on bulk and porous silicon. Nanoscale Research Letters 2013 8:85. doi:10.1186/1556-276X-8-85).

The average diameter of the particles is calculated by comparing the particles in the shape of irregular spheres and taking the largest diameter. Conductive materials which may be used in the present invention may be selected from glasses with conductive coatings, composites based on plastic polymers or metal foils.

The conductive glass is a structure in which the glass is covered with a conductive oxide.

Preferably, the conductive glass that is used is a TCO conductive glass (transparent conducting oxide glass). The requirements of the TCO glass are a low electrical resistance in the oxide layer and a high transparency to solar radiation in the visible/NIR range. For the layer of oxide there may be used tin oxide doped with indium (indium tin oxide, ITO), and tin oxide doped with fluorine (FTO). The TCO glass preferred for the present invention is FTO.

Preferably, the composite based on plastic polymers is polyethylene terephthalate covered with ITO (PET/ITO).

Among the advantages of this kind of conductive materials, the main ones are the reduced weight, the flexibility and the ease of scaling up to industrial processes, such as roll-to-roll printing.

The metal foils may preferably be of titanium, aluminium or stainless steel. Metal foils have the same advantages as polymer-based materials.

Processes known from the prior art for the deposition of Pt on FTO conductive glass provide the following steps:
i. dissolving a precursor of Pt in an organic solvent to form a solution;
ii. successively depositing the solution formed at step (i) onto FTO to form a substrate;
iii. heating said substrate to approximately 500° C.

By contrast, in order to prepare the electrodes described and claimed in the present document, a different sequence in the steps has to be followed.

Thus, a further subject matter of the present invention is a new process for the preparation of the electrode described and claimed in the present document, comprising the following steps:
a. dissolving a precursor containing one or more metals selected from platinum, palladium, gold and mixtures thereof in an organic solvent to form a solution;
b. heating a conductive material to a stable temperature of at least 250° C., preferably between 350° C. and 550° C.;
c. depositing the solution formed at step (a) containing the precursor on the heated conductive material by a spray technique.

Numerous organic solvents are suitable for dissolving the precursors of the metals used to create the electrode which forms the subject matter of the present invention. The fundamental point is to select organic solvents in which the precursors of the metals are soluble, and so in which no particulates remain in suspension. Preferred organic solvents are selected from ethyl acetate, acetonitrile, tetrahydrofuran, toluene, diethylether, hexane, heptane, sulfolane, glycerol, acetone, ethanol, methylene chloride, tetrachloroethane, acetic acid, or water.

Preferred solvents are mixtures of water with organic solvents, or mixture of organic solvents. More preferred solvents are mixtures of water with one of the solvents selected from ethyl acetate, acetonitrile, tetrahydrofuran, toluene, diethylether, hexane, heptane, sulfolane, glycerol, acetone, ethanol, methylene chloride, tetrachloroethane, acetic acid.

The solution containing the precursors of the metals that is formed in step (a) is sprayed by a spray technique onto the heated conductive material. Apparatus for spraying the solution that is obtained at step (a) may be nozzles or spray guns. In these cases, the term used is the “spray pyrolysis” process, where pyrolysis occurs with the heating of the conductive material. The operating principle of a spray gun is that a carrier gas (nitrogen) creates a negative pressure inside a nozzle, and this draws the solution to the outlet by suction.

Precursors containing metals that are suitable for the purposes of the present invention are selected, purely by way of example, from Pt(acac)₂, Pt(NH₃)(NO₃)₂, Pd(acac)₂, H₂PtCl₆, H₂PdCl₄, HAuCl₄, and, in the case of these last, as their salts with counterions such as tetrabutylammonium or other cations of quaternary ammonium, such as (NH₄)₂(PtCl₆) and NBu₄(AuCl₄), among others.

The average diameter of the particles may be optimised by varying the concentration of the precursor, which may vary between 0.1% and 20% by weight, preferably between 0.3% and 10% by weight, by varying the concentration of the metal and the number of spray operations, which is between 5 and 40, preferably between 5 and 25.

The greater the concentration of the precursor and the number of spray operations, the greater the average diameter of the particles.

To heat the conductive material, heating plates that are able to heat to 550° C.-600° C. may be used.

Thanks to the new process for the preparation of the electrodes described and claimed in the present patent application, it is possible to obtain a new morphology that gives surprising results for a large number of ways.

Said process for preparation, and in particular the spray pyrolysis process, give a markedly inhomogeneous distribution of the metal, or to be precise of the porous crosslinked layer, and this distribution is characterised by a broad distribution of the particles of metal having an average diameter greater than 80 nm, determined by SEM, at temperatures at which in the conventional procedure of thermal decomposition particles having a significantly lower average diameter are obtained, less than 30 nm.

The results are also surprising in a further way, in that, in contrast to the teachings of the prior art, the performance of the cells that is obtained is significantly superior, as illustrated by the examples and comparatives examples given, even though the dimensions of the particles are almost two orders of magnitude greater than the dimensions identified as optimal by the prior art (approximately 5 nm).

M. Grätzel et al., J. Electrochem. Soc., Volume 144, Issue 3, pp. 876-884, 1997, describe nanoparticles of Pt of approximately 5 nm which are obtained from the thermal decomposition of H₂PtCl₆ dissolved in isopropanol, which is carried out at a temperature of 385° C.; these particles prove to be those giving the best performance of those described in the said publication. Moreover, it is also surprising that such performance is better with a highly irregular morphology, in which the particles are shown to be fused together, where the literature unanimously recommends the use of electrodes characterised by a distribution of well isolated particles to form a homogeneous distribution on the support.

Surprisingly, the use of the spray pyrolysis process allows the use of a greater number of precursors of the metal and of solvents which cannot be used in the conventional process, in that in some cases the absence of deposition of metal (for example platinum) on the FTO support can be observed (as detailed below in the experimental section).

Apart from the efficiency (η), both the open circuit voltage (V_{oc}) and the short circuit current (J_{sc}) are increased.

A further subject matter of the present invention is a photovoltaic cell comprising the electrode described and claimed in the present document.

Preferably, the photovoltaic cells are organic, and more preferably they are for example those called dye sensitised solar cells (DSSCs).

A further subject matter of the present invention is a photovoltaic cell, preferably of the DSSC type, which comprises, in addition to the electrode described and claimed in the present document, a semiconductor electrode onto which a photosensitising dye can be grafted and an electrolyte containing a redox couple.

All known semiconductor electrodes, dyes, electrolytes and redox couples may be used in the photovoltaic cells, and in particular the DSSC-type photovoltaic cells, which form the subject matter of the present invention. In particular, as the semiconductor electrode there may be used compounds selected from TiO₂, ZnO, CdSe, CdS, preferably TiO₂. The electrolyte may be selected from those well known to those skilled in the art, including for example those described in Dye Sensitized Solar Cells (eds. K. Kalyanasundram, EPFL Press, distributed by CRCC Press, 2010, pp. 28-29), and preferably iodine containing a redox couple I₂/I₃. A typical composition may for example contain: N-methyl-N-butylimidazolium iodide, iodine, LiI, guanidinium thiocyanate and ter-butylpiridine, in a mixture, for example 15:85 in volume, of valeronitrile and acetonitrile. The dye may for example be selected from those known from the prior art, including for example those described in Dye Sensitized Solar Cells (eds. K. Kalyanasundram, EPFL Press, distributed by CRCC Press, 2010, pp. 24-28). Dyes which are widely used are for example those in the class of bipyridine complexes of ruthenium (II), commonly called N719 (di-tetrabutylammonium cis-bis(isothiocyanato)bis(2,2′-bipyridyl-4,4′-dicarboxylato)ruthenium(II)) and N3 (cis-bis(isothiocyanato)bis(2,2′-bipyridyl-4,4′-dicarboxylato)ruthenium (II)), or those in the class of metal-free organic dyes, which are well known to those skilled in the art, and of which there is a good review in “Metal-Free Organic Dyes for Dye-Sensitized Solar Cells: From Structure: Property Relationships to Design Rules” A. Mishra, M. K. R. Fisher, P. Bäuerle, Angew. Chem. Int. Ed. 2009, vol. 48, pp. 2474-2499.

A further subject matter of the present invention is a method for the conversion of solar energy into electricity which uses the photovoltaic cell described and claimed here.

Finally, a subject matter of the present invention is the use of the electrode described and claimed as the cathode in photovoltaic cells, preferably of the DSSC type.

### EXAMPLES

Illustrated below are some examples that describe particular embodiments of the present invention.

The examples specify the preparations of electrodes that were prepared by spray pyrolysis from precursors of Pt and Au in organic solvents. The apparatus for spray pyrolysis deposition substantially comprised a spray gun or nozzle, and a heating plate where pyrolysis of the precursor was carried out. The heating plate comprised a plate having dimensions of 12×12 cm and capable of heating the samples to 600° C. The output measurements were carried out using a balance on which the precursor container had been placed. All the equipment was controlled by means of three manual valves operated by the operating personnel.

It is shown that the deposition by spray pyrolysis creates the specific morphology described in the present patent application as a porous crosslinked layer. The diameter of the particles was determined by scanning electron microscopy (SEM), as described in the literature (Bandarenka et al.: Comparative study of initial stages of copper immersion deposition on bulk and porous silicon. Nanoscale Research Letters 2013 8:85. doi:10.1186/1556-276X-8-85). The examples compare the performance of the suitably prepared cathodes.

For the purpose of clarity, it should be mentioned that the comparisons refer to electrodes prepared in the same laboratory, and are not compared with the maximum efficiency values reported in the literature since, as is known from the prior art, a marked variability in the absolute values occurs from one laboratory to the next, whereas these comparisons between electrodes are highly significant.

### Example 1

Pt was deposited from a solution of Pt(acac)₂ in acetone 1.24% w/w onto FTO conductive material (2×2 cm). The temperature of the heating plate was set to 560° C. such that the temperature of the conductive material fixed to the plate, measured using a thermocouple brought into contact with the conductive material, reached a stable value of 450° C. The following procedure was used to perform 15 spray operations on the conductive material: 10 seconds of spraying, 3 minutes of heat treatment between two successive spray operations. The spray gun output was maintained at approximately 0.181 g/sec. The SEM images of the sample that was deposited are shown in FIG. 1. The FTO layer is completely covered. Dimensions of the particles=190 (2) nm (the number in brackets for this measurement indicates that the value is 190+/−2).

### Example 2

Pt was deposited from a solution of Pt(acac)₂ in acetone 0.62% w/w onto FTO conductive material (2×2 cm). The temperature of the heating plate was set to 560° C. such that the temperature of the conductive material fixed to the plate, measured using a thermocouple brought into contact with the conductive material, reached a stable value of 450° C. The following procedure was used to perform 10 spray operations on the conductive material: 10 seconds of spraying, 3 minutes of heat treatment between two successive spray operations. The spray gun output was maintained at approximately 0.190 g/sec. The SEM images of the sample that was deposited are shown in FIG. 2. The FTO layer is completely covered. Dimensions of the particles=80 (1) nm (the number in brackets for this measurement indicates that the value is 80+/−1).

### Example 3

Pt was deposited from a solution of Pt(NH₃)₄(NO₃)₂ 2.3% w/w in an acetone/water mixture of 50/50 v/v onto FTO conductive material (2×2 cm). The temperature of the heating plate was brought to 560° C. such that the conductive material fixed to the plate reached a temperature of 450° C. The following procedure was used to perform 15 spray operations on the conductive material: 10 seconds of spraying, 3 minutes of heat treatment between two successive spray operations. The spray gun output was maintained at approximately 0.187 g/sec. The SEM images of the sample that was deposited are shown in FIG. 3. The FTO layer is completely covered. Dimensions of the particles=120 (2) nm (the number in brackets for this measurement indicates that the value is 120+/−2).

### Example 4

Pt was deposited from a solution of Pt(NH₃)₄(NO₃)₂ 1.2% w/w in an acetone/water mixture of 50/50 v/v onto FTO conductive material (2×2 cm). The temperature of the heating plate was set to 560° C. such that the temperature of the conductive material fixed to the plate, measured using a thermocouple brought into contact with the conductive material, reached a stable value of 450° C. The following procedure was used to perform 18 spray operations on the conductive material: 10 seconds of spraying, 3 minutes of heat treatment between two successive spray operations. The spray gun output was maintained at approximately 0.187 g/sec. The SEM images of the sample that was deposited are shown in FIG. 4. The FTO layer is completely covered. Dimensions of the particles=100 (1) nm (the number in brackets for this measurement indicates that the value is 100+/−1).

### Example 5

Au was deposited from a solution of NBu₄(AuCl₄) (prepared according to Chi-Ming Che, Raymond Wai-Yin Sun, Wing-Yiu Yu, Chi-Bun K, Nianyong Zhu and Hongzhe Sun, Chem. Commun., 2003, 1718-1719, DOI: 10.1039/B303294A) 5% w/w in a water/acetonitrile mixture of 5/95 v/v onto FTO conductive material (2×2 cm). The temperature of the heating plate was set to 560° C. such that the temperature of the conductive material fixed to the plate, measured using a thermocouple brought into contact with the conductive material, reached a stable value of 450° C. The following procedure was used to perform 15 spray operations on the conductive material: 10 seconds of spraying, 3 minutes of heat treatment between two successive spray operations. The spray gun output was maintained at approximately 0.187 g/sec. The SEM images of the sample that was deposited are shown in FIG. 5. The FTO layer is completely covered. Dimensions of the particles=80 (1) nm (the number in brackets for this measurement indicates that the value is 80+/−1).

### Comparative Example 6

A commercial sample of Dyesol (Pt-Coated Test Cell Glass Plate) formed by an FTO conductive glass (TEC15), onto the surface of which there was deposited Pt obtained from thermal decomposition, was used (http://www.dyesol.com/download/Catalogue.pdf).

FIG. 6 shows an SEM image of the sample deposited. The FTO layer is only partly covered. The sample displays a morphology comprising particles of Pt having dimensions of 8-10 nm, which decorate the conductive material, partly according to the morphology. It is seen that the deposition of Pt is sparse and largely inhomogeneous.

### Comparative Example 7

A solution of 2% by weight of H₂PtCl₆.6H₂O in H₂O was prepared. The solution was deposited on a conductive FTO glass (FTO glass 25 cm×25 cm TEC 8 2.3 mm) with masked regions, and the slide was put in an oven at 92° C. for 20 hours. The masking was detached, the slide was cleaned of any residual glue from the adhesive tape and baking was carried out in a muffle furnace, with a rising gradient ending at 400° C. after 3 hours, and the temperature was then maintained at 400° C. for 1 hour. FIG. 7 shows an SEM image of the sample that was deposited. The FTO layer is only partly covered. The sample displays a morphology comprising a layer of nanoaggregates varying in dimension but <100 nm, formed by particles of Pt of 8-10 nm, which is not compact and displays a semi-gelatinous morphology which follows and decorates the conductive material of the sample: this layer does not cover the conductive material (FTO) uniformly, leaving holes of irregular shape and sub-micron dimensions.

### Comparative Example 8

A solution of 2% by weight of H₂PtCl₆.6H₂O in isopropanol was prepared. The solution was deposited on a glass with masked regions, and the slide was put in an oven at 100° C. for approximately 20 hours. The masking was detached, the slide was cleaned of any residual glue from the adhesive tape and baking was carried out in a muffle furnace, with a rising gradient ending at 400° C. after 3 hours, and then at 400° C. for 1 hour. The figure shows an SEM image of the sample that was deposited. The FTO layer is completely covered by multiple layers.

### Comparative Example 9

A solution of 2% by weight of Pt(acac)₂ in acetone was prepared. The solution was deposited on a glass with masked regions, and the slide was put in an oven at 100° C. for approximately 20 hours. The masking was detached, the slide was cleaned of any residual glue from the adhesive tape and baking was carried out in a muffle furnace, with a rising gradient ending at 400° C. after 3 hours, and then at 400° C. for 1 hour. The FTO layer is not covered with Pt, which was not deposited during the preparation.

### Example 10

The electrode prepared according to Example 1 was tested in a DSSC cell, using as the photoanode an electrode based on TiO₂. Electrodes based on TiO₂ were prepared by spreading (by the doctor-blade technique) a colloidal paste containing particles of TiO₂ having dimensions of 20 nm (TiO₂ DSL 18NR-T paste—Dyesol—http://www.dyesol.com/download/MatPaste.pdf) onto a conductive FTO glass (si-Hartford Glass Co., TEC 8, having a thickness of 2.3 mm and a resistance of 6-9 Ω/cm²), previously washed with water and ethanol. After an initial drying process for 15 minutes at 125° C., the sample was calcined for 30 minutes to 500° C. After the calcination, the glass covered with the layer of TiO₂ was cooled to room temperature and immersed in a solution of dichloromethane (CH₂Cl₂) [5×10⁻⁴ M] with N719 as the dye, for 24 hours at room temperature (25° C.). The glass was then washed with ethanol and dried at room temperature (25° C.) under a stream of N₂. A spacer of Surlyn 50 microns thick (TPS 065093-50—Dyesol—http://www.dyesol.com/index.php?element=MattSealants) was used to seal the photoanode and the cathode prepared according to Example 1, and then the cell was filled with an electrolyte solution of the following composition: N-methyl-N-butylimidazolium iodide (0.6 M), iodine (0.04 M), LiI (0.025 M), guanidinium thiocyanate (0.05 M) and ter-butylpyridine (0.28 M), in a mixture of 15:85 by volume of valeronitrile and acetonitrile. The active area of the cell, calculated by microphotography, was measured as 0.1435 cm². The performance of the photovoltaic cell was measured using a solar simulator (Abet 2000) equipped with a 300 W xenon light source, and the intensity of the light was regulated using a silicon calibration standard (“VLSI standard” SRC-1000-RTD-KG5); performance was measured by applying voltage to the cell and measuring the photocurrent generated, using a “Keithley 2602A” (3 A DC, 10 A pulse) digital source meter. The results obtained are indicated below:

η=6.6%

### FF=72.4%

### V_{oc}=722 mV

J_{sc}=12.62 mA/cm²

### Example 11

A DSSC-type photovoltaic cell according to the description under Example 10 was prepared using the same components as those indicated in Example 10 except for the platinum electrode, which was that prepared in Example 2; the performance obtained is indicated below:

η=5.9%

### FF=71.2%

### V_{oc}=778 mV

J_{sc}=10.65 mA/cm²

### Example 12

A DSSC-type photovoltaic cell according to the description under Example 10 was prepared using the same components as those indicated in Example 10 except for the platinum electrode, which was that prepared in Example 3; the performance obtained is indicated below:

η=7.5%

### FF=72.3%

### V_{oc}=791 mV

J_{sc}=13.11 mA/cm²

### Example 13

A DSSC-type photovoltaic cell according to the description under Example 10 was prepared using the same components as those indicated in Example 10 except for the platinum electrode, which was that prepared in Example 4; the performance obtained is indicated below:

q=7.1%

### FF=70.3%

### V_{oc}=782 mV

J_{sc}=12.94 mA/cm²

### Comparative Example 14

A DSSC-type photovoltaic cell according to the description under Example 10 was prepared using the same components as those indicated in Example 10 except for the platinum electrode, which was that prepared in Example 6; the performance obtained is indicated below:

q=3.1%

### FF=58.6%

### V_{oc}=689 mV

J_{sc}=7.67 mA/cm²

### Comparative Example 15

A DSSC-type photovoltaic cell according to the description under Example 10 was prepared using the same components as those indicated in Example 10 except for the platinum electrode, which was that prepared in Example 8; the performance obtained is indicated below:

η=4.2%

### FF=61.4%

### V_{oc}=723 mV

J_{sc}=9.46 mA/cm²

1. Electrode comprising a conductive material and characterised by the fact of containing a porous crosslinked layer of metal particles, said metal particles being fused between them by a part of their outer surface, still leaving the remaining portion of the outer surface free, said particles being characterised in that they contain one or more metals selected from platinum, palladium, gold and mixtures thereof.

2. Electrode according to claim 1, in which the particles have an average diameter greater than 80 nm.

3. Electrode according to claim 2, in which the particles have an average diameter between 80 nm and 190 nm.

4. Electrode according to claim 1, in which the particles have irregular polyhedral shape or have a curved outer surface.

5. Electrode according to claim 1, in which the conductive material is selected from glasses with conductive coatings, composites based on plastic polymers or metal foils.

6. Electrode according to claim 5, in which the glass with a conductive coating is covered with tin oxide doped with indium or tin oxide doped with fluorine.

7. Electrode according to claim 5, in which the composite based on plastic polymers is polyethylene terephthalate covered with tin oxide doped with indium.

8. Electrode according to claim 5, in which the metal foils are selected from titanium, aluminium and stainless steel.

9. Process for the preparation of an electrode according to claim 1, comprising the following steps:
a. dissolving a precursor containing one or more metals selected from platinum, palladium, gold and mixtures thereof in an organic solvent to form a solution;
b. heating a conductive material to a stable temperature of at least 250° C.;
c. depositing the solution formed at step (a) containing the precursor on the heated conductive material by a spray technique.

10. Process according to claim 9, in which the conductive material is heated to a stable temperature between 350° C. and 550° C.

11. Process according to claim 9, in which the organic solvents are selected from ethyl acetate, acetonitrile, tetrahydrofuran, toluene, diethylether, hexane, heptane, sulfolane, glycerol, acetone, ethanol, methylene chloride, tetrachloroethane, acetic acid, or water.

12. Process according to claim 9, in which the precursors are selected from Pt(acac)₂, PONH₃)(NO₃)₂, Pd(acac)₂, H₂PtCl₆, H₂PdCl₄, HAuCl₄, and, in the case of the latter three compounds as their salts with counterions such as tetrabutylammonium or other cations of quaternary ammonium.

13. Photovoltaic cell comprising an electrode according to claim 1, a semiconductor electrode onto which a photosensitising dye can be grafted and an electrolyte containing a redox couple.

14. Use of an electrode according to claim 1 as the cathode in DSSC-type photovoltaic cells.

15. Method for the conversion of solar energy into electricity which uses the photovoltaic cell according to claim 13.
